(19) United States
(12) Patent Application Publication
(10) Pub. No.: US 2015/0294346 A1
(43) Pub. Date: Oct. 15, 2015

(54) STATE INFORMATION SESSION TOKEN

(71) Applicant: Valassis Communications, Inc., Livonia, MI (US)

(72) Inventors: Rinaldo Salvatore Di Giorgio, Easton, CT (US); Madelyn Lindsay Law Schroeder, Grosse Pointe Farms, MI (US)

(73) Assignee: Valassis Communications, Inc., Livonia, MI (US)

(21) Appl. No.: 14/249,015

(22) Filed: Apr. 9, 2014

(51) Int. Cl. G06Q 30/02; H04L 29/06

(52) U.S. Cl. CPC G06Q 30/0239; H04L 63/0853

(57) ABSTRACT

A system includes register a received token, generated by a web browser client of a client device, as being associated with a web session of the web browser client, receive a request including the token from a secure application of the client device, identify state information according to the web session of the web browser client associated with the token, and send the state information to the secure application of the client device responsive to the request.

### TECHNICAL FIELD

The disclosure generally relates to a system and method for managing sessions by way of a generated key or token passed between a client and a server.

### BACKGROUND

The advent of the Internet has revolutionized many industries. For example, the Internet has allowed the couponing industry to provide electronic distribution of coupons, vouchers or other incentives through delivery channels including e-mail and the World Wide Web. Accordingly, rather than manually clipping coupons from physical newspapers or advertisement with a pair of scissors, a user may access digital offers from a website and may select from the website which offers to print.

It may be desirable to track users who request digital offers, such that an offer may be provided only a limited number of times to a single user or device. One technique to uniquely identify a user device is by way of browser fingerprinting. However, such techniques may not offer unique identification in some cases (e.g., for similar computers running an imaged software installation), or overly unique identification in other cases (e.g., when device or software configuration changes). Moreover, such techniques may also raise privacy issues with respect to the information being collected.

### SUMMARY

According to one or more embodiments of the present application, a system includes an application server configured to register a received token, generated by a web browser client of a client device, as being associated with a web session of the web browser client, receive a request including the token from a secure application of the client device, identify state information according to the web session of the web browser client associated with the token, and send the state information to the secure application of the client device responsive to the request.

According to one or more additional embodiments, a system includes a client device is configured to generate a token uniquely identifying the client device according to web page code of a website provided to the client device from an application server in a web session, send the token to the application server to cause the application server to associate the token with the web session, send a request including the token from a secure application of the client device, and receive state information associated with the web session from the application server responsive to the request.

According to one or more additional embodiments, a method for distributing digital offers includes generating, by a client device, a token uniquely identifying the client device according to web page code of a website provided to the client device from an application server in a web session, sending the token by the client device to the application server to cause the application server to associate the token with the web session, sending a print request including the token from a secure application of the client device, and receiving digital offers associated with the web session from the application server for printing by secure application.

### BRIEF DESCRIPTION OF THE DRAWINGS

FIG. 1 illustrates an exemplary block diagram of an online offer distribution system;

FIG. 2A illustrates an exemplary flow diagram of a client device requesting a digital offer without having a secure application installed;

FIG. 2B illustrates an exemplary flow diagram of the client device requesting the digital offer having the secure application installed;

FIG. 3A illustrates an exemplary user interface of the client device including a web page of the online offer distribution website for requesting digital offers;

FIG. 3B illustrates an exemplary user interface of the client device for receiving an application installer of the secure application;

FIG. 3C illustrates an exemplary user interface of the client device for installing the downloaded secure application;

FIG. 3D illustrates an exemplary user interface of the client device including a web page of the online offer distribution website for performing a protocol request to invoke the secure application to complete the digital offer request;

FIG. 4 illustrates an exemplary process for printing digital offers provided by the application server to the client device;

FIG. 5 illustrates an exemplary process for providing the secure application to the client device from the application server; and

FIG. 6 illustrates an exemplary process for providing digital offers from the application server to the client device executing the secure application.

### DETAILED DESCRIPTION

Detailed embodiments of the present invention are disclosed herein. However, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Implementations of illustrative embodiments disclosed herein may be captured in programmed code stored on machine readable storage mediums, such as, but not limited to, computer disks, CDs, DVDs, hard disk drives, programmable memories, flash memories and other permanent or temporary memory sources. Execution of the programmed code may cause an executing processor to perform one or more of the methods described herein in an exemplary manner.

Because web browsers may attempt to protect users from being identified, transferring user-identifying state information from a web browser may be difficult to perform without system requests for security elevation. However, users may find these privilege requests to be annoying or confusing, reducing user acceptance of the system.

To avoid these security issues, a token may be utilized by the secure digital offer system to link state information between a client and a server. For example, when requesting a digital offer from a coupon web site, the web browser may identify whether a secure printing application is installed on the client. If the secure application is not installed, the web browser may be configured to generate a token, and send the token to the server. The server may be configured to receive and register the token, generate a filename that contains or otherwise encodes the token, and return to the web browser an installer executable named according to the generated filename. The installer named according to the token may be referred to herein as a keyed executable. When the keyed executable is launched by the client, the executable may read in its own filename, install the secure application, decode or otherwise retrieve the token, and forward the registered token to the server using the secure application to continue the transaction.

By registering the token with the browser session requesting the installer executable, the server may accordingly link the newly-installed secure application to the existing browser session from which it was requested. Once linked, the server may now provide the originally requested digital offers selected during the web session via the secure application. Thus, as the web browser client receives the keyed installer executable with the necessary token information to continue the initial request, the user may be able to install and use the secure application immediately, without requiring further transfer of state information from the web browser to the secure application.

Moreover, as the filename of the keyed executable is utilized to pass information to the application, the keyed executable technique may operate without embedded custom data within the executable. This is beneficial because embedded application data may be rejected by a system virus scanner as a potential vector for virus injection, and further because such embedded application data requires additional server resources and time to embed the data and then sign the custom executable. Accordingly, the keyed executable technique may be relatively quick to perform by the server and also immune to firewall rejection resulting from inclusion of embedded data within the executable.

Once the secure printing application is installed to the client, the application may be used to process additional requests for digital offers. In an example, the installed application may register a handler for a custom universal resource locator (URL) protocol, such that the application may be invoked on the client device to process URLs directed to the custom protocol type. Then, to complete a request for a digital offer, the web browser may be configured to send a generated token to the web server, and receive a protocol request including the token from the web server to execute the secure application. The token may accordingly be identified by the secure application via the protocol request, and provided to the server by the secure application to continue the current session and print the requested offer.

As the secure application may install itself on the client device as a service to handle substantially all protocol requests of the custom type, other web browsers of the client device may also be able to utilize the secure application to handle protocol requests to request the digital offers, without requiring separate application installations. Accordingly, a further advantage of the secure application is that it may allow the server to use a single client installation to provide digital offers across multiple browser applications and versions.

While the disclosure describe use of the secure application, token, and keyed executable in relation to digital offers, it should be noted that the described concepts are applicable to other web applications utilizing a secure application sharing state with a web browser session on the same client device. As an example, the disclosed approach may be utilized for an online banking or accounting website having a secure client application sharing state with the web browser. As another example, the disclosed approach may be utilized for a remote login or terminal services website specifying options used to launch a secure terminal application.

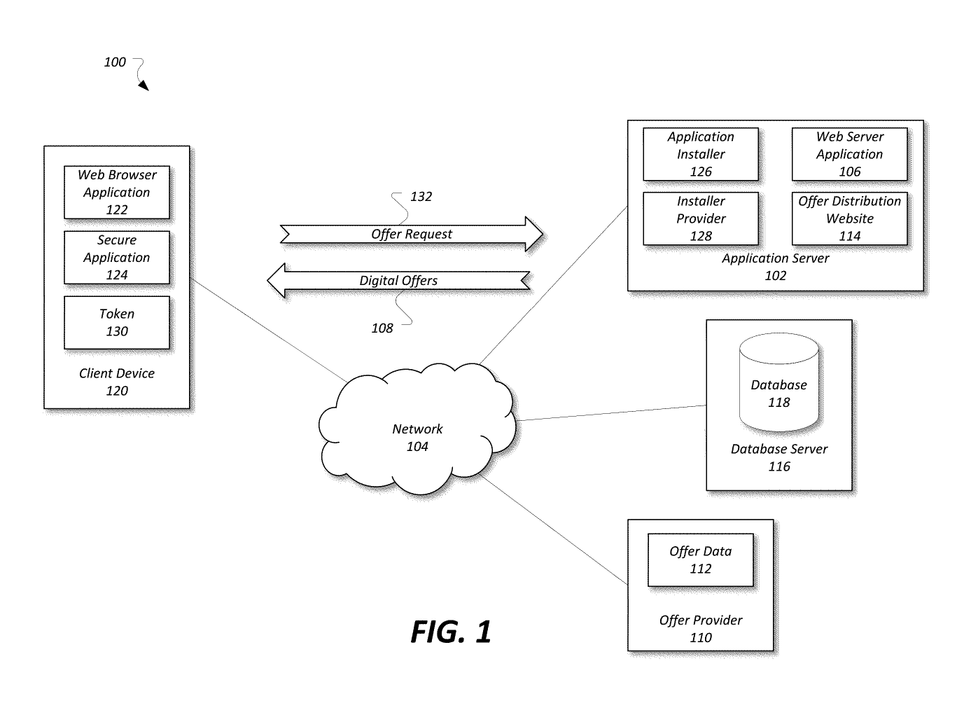

A high-level block diagram of an exemplary secure digital offer system 100 is illustrated in FIG. 1. As illustrated, the system 100 includes an application server 102 having a web server application 106, an application installer 126, an online offer distribution website 114 for providing digital offers 108, and an installer provider 128. The system 100 further includes an offer provider 110 having offer data 112 to be provided to the application server 102. The system 100 also includes a database server 116 having a database 118 configured to provide storage facilities for the application server 102. Additionally, the system 100 includes a client device 120 configured to execute a web browser 122 and a secure application 124, and that may generate tokens 130 to identify the client device 120 to the application server 102. Each of these devices may communicate with each other via a communications network 104. For example, the client device 120 may send an offer request 132 to the application server 102, and the application server 102 may respond with the requested digital offers 108. Variations on the exemplary system 100 are possible. For example, while only one client device 120 is illustrated, systems including many client devices 120 are likely and contemplated. As another possibility, while the application server 102 and the database server 116 are illustrated as separate computing devices, in some examples the application server 102 and database server 116 may be combined in a single server machine.

The application server 102 may provide one or more functions or services to connected devices. To do so, the application server 102 may be configured to execute programs on one or more processors, where the programs are stored on one or more memory devices of the application server 102. The application server 102 may further include network hardware configured to allow the application server 102 to communicate with the connected devices over the communication network 104. The communication network 104 may include one or more suitable communications networks, such as the Internet, a cable network, a satellite network, a local area network, a wide area networks, and a telephone network.

One application or service provided by the application server 102 may be to provide web services to connected clients. For instance, the application server 102 may be configured to execute a web server application 106 configured to utilize components of the application server 102 for the construction and providing of web pages. An online offer distribution website 114 may be one example of a website provided by the web server application 106. The online offer distribution website 114 may include one or more web pages served by the web server application 106 and configured to convey offer content relating to one or more digital offers 108 (e.g., promotions, coupons, incentives, etc.) to users of the system. Once received and printed by users, the digital offers 108 may be redeemed by the users at retailers or other point of sale (POS) locations.

The offer providers 110 may be configured to make offer data 112 available to users of the system 100 via the online offer distribution website 114. Thus, the offer providers 110 may be configured to provide offer data 112 to the application server 102 for use in the generation of the online offer distribution website 114 by the web server application 106. In some cases, the online offer distribution website 114 may provide digital offers 108 according to offer data 112 received from a single offer provider 110. In other cases, the online offer distribution website 114 may be a web portal configured to provide digital offers 108 according to an aggregation of offer data 112 from multiple offer providers 110 into a single online offer distribution web site 114.

Exemplary offer providers 110 may include consumer packaged goods manufacturers (CPGs), retailers, service providers, restaurants, or other entities that may wish to use the services of the application server 102 to distribute digital offers 108 to users. The offer data 112 may include information such as product name, offer type indicator, a product image associated with the offer, an offer provider or brand logo, a savings value statement and offer description (e.g., save $2.00 on three), offer instructions, one or more machine-readable codes (e.g., barcodes), that may be useful for generation of digital offers 108 to be provided to users of the system.

In addition to distributing offers via the online offer distribution website 114, the application server 102 may be further configured to facilitate the management of the offer data 112 provided by the one or more offer providers 110. For example, the web server application 106 or another application of the application server 102 may be configured to provide a portal (e.g., a web portal) for offer providers 110 to generate, edit and manage offer data 112 according to their own business rules. The portal may allow an offer provider 110 to access and control its incentivizing initiatives. For instance, the portal may be configured to allow the offer provider 110 to set or modify offer data 112 campaign-based print limits and/or device-based print limits imposed on offers provided via the online offer distribution website 114. The portal may be further configured to provide reporting features to the offer providers 110. Using the portal, an offer provider 110 may be able to track user printing and redemption of offers. While the portal may allow offer providers 110 to track information such as user views, prints, redemptions, the geographic distribution of offers, it should be noted that the portal (and the system 100 generally) may not directly associate an offer to a specific user. Thus, specific customer statistics and personally-identifiable customer information may be unavailable.

The database server 116 may provide database services to the application server 102. Information stored in the database 118 may be requested from the database server 116 through the application server 102. Accordingly, the database server 116 may handle tasks such as data analysis and storage. For example, the database server 116 may be configured to maintain offer data 112 for use by the application server 102 in generation of and updating of the online offer distribution website 114. The database server 116 may also be configured to maintain information corresponding to how many print requests 132 are received for each offer data 112. As another example, the database server 116 may be configured to maintain information indicative of rules for when an offer should be issued to a user of the online offer distribution website 114, and to whom it should be issued. As offers may expire, the database server 116 may be configured to maintain expiration information for offers that have been provided to the users. The expiration information may include predefined conditions upon which the offers may expire, such as a date certain, a number of days to expiration, a number of views, or a number of prints.

The client device 120 may be computing device having networking functionality, such as a personal computer, a portable computer, a personal digital assistant (PDA), a mobile phone, a tablet device, a microprocessor-based entertainment appliance, or a set-top-box, as some examples. The client device 120 may be configured to execute programs on one or more processors, where the programs are stored on one or more memory devices of the client device 120. The client device 120 may further include network hardware configured to allow the client device 120 to communicate with the application server 102 over the communication network 104. The client device 120 may also include input hardware configured to receive input to be provided to the client device 120. Exemplary input hardware may include still cameras and video cameras for capturing video input, microphones for capturing audio input, and one or more buttons or other user controls for capturing input from a user of the client device 120. The client device 120 may also include output hardware such as one or more displays to provide visual output, one or more speakers to provide audio output, and one or more haptic devices to provide haptic feedback to users of the device. The input hardware and output hardware may be used by the client device 120 to provide a user interface between the client device and users of the client device 120.

The web browser 122 may be one such example of an application program stored on the memory of the client device 120 (e.g., as software, firmware, etc.). The client device 120 may be configured to execute the web browser 122 to navigate to servers such as the application server 102 and thereby to access the one or more functions or web services provided by the servers. The web browser 122 may accordingly be configured to display a web-based user interface via the user interface hardware of the client device 120. For example, the client device 120 may utilize the web browser 122 to access the online offer distribution website 114 provided by the web server application 106 to access digital offers 108 made available online by the offer providers 110. A user of the client device 120 may utilize the web browser 122 to visit the online offer distribution website 114 to view and potentially print one or more available digital offers 108.

The secure application 124 may be another example of an application program stored on the memory of the client device 120. The secure application 124 may be configured to facilitate the download and printing of digital offers 108 requested by the user from the online offer distribution website 114. The secure application 124 may be further configured to implement controls and other appropriate security features to prevent and/or minimize the fraudulent use of digital offers 108 distributed online via the system 100. For example, the secure application 124 may employ security features to prevent the unauthorized viewing, copying, modifying, printing, screen grabbing, saving and distributing of digital offers 108 provided to the client device 120.

To initiate the secure transfer of digital offers 108, the secure application 124 may be configured to register its own protocol such that the secure application 124 may be executed from the web browser 122 by a link or URL specifying the custom protocol. As one possibility, the protocol may be named and referenced in protocol requests as “printathome.” In such an example, an exemplary web link configured to invoke the secure application 124 to handle the protocol request may be “printathome:protocol-print [parameters],” where “[parameters]” may be replaced by an identifier or other particulars of the specific digital offers 108 being requested for printing. The secure application 124 registered to handle protocol requests to the custom protocol may accordingly be invoked via the web browser 122 to handle URLs of the customer protocol type. For instance, when executed from the web browser 122, the secure application 124 may be invoked using a command line specifying the body of the protocol request, e.g., “protocol-print [parameters].”

Because the functionality of the secure application 124 is required for the client device 120 to securely print digital offers 108, before allowing a user of the client device 120 to receive digital offers 108, the application server 102 may require that the secure application 124 be installed on the client device 120. Accordingly, the application server 102 may host an application installer 126 that may be downloaded by the client device 120. When executed by the client device 120, the application installer 126 may be configured to install the secure application 124 onto a memory of the client device 120. The application server 102 may be further configured to host an installer provider 128 configured to handle client device 120 requests to download the application installer 126.

The token 130 may be a relatively unique identifier that may be generated by the client device 120 and provided to the application server 102. As some possibilities, the token 130 may be a random alphanumeric string (e.g., 8 digits in one example), a random value of a different length or type, or another relatively unique identifier that that may be representable in a text format, such as a globally-unique identifier (GUID). In an example, the online offer distribution website 114 may include web page code (e.g., JavaScript code) that when executed by the web browser 122 of the client device 120 causes the client device 120 to generate the token 130. When provided to the application server 102, token 130 may be registered at the application server 102 and used to link later requests to the application server 102 to state information of the web browser 122 session providing the token 130.

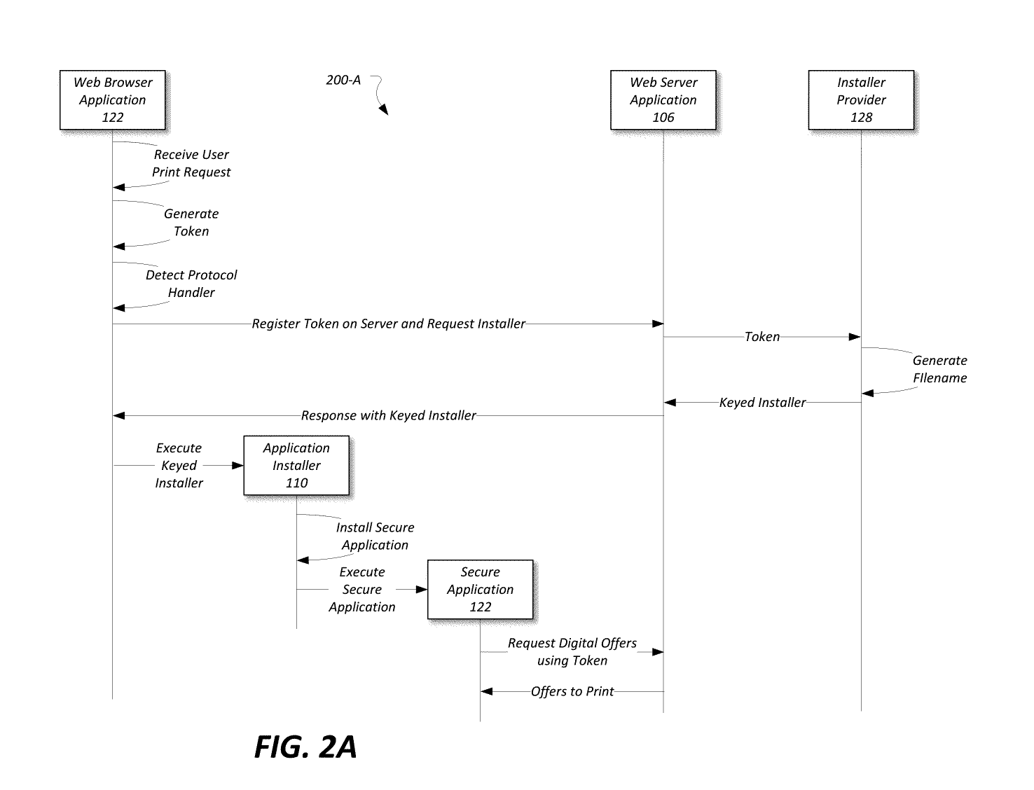

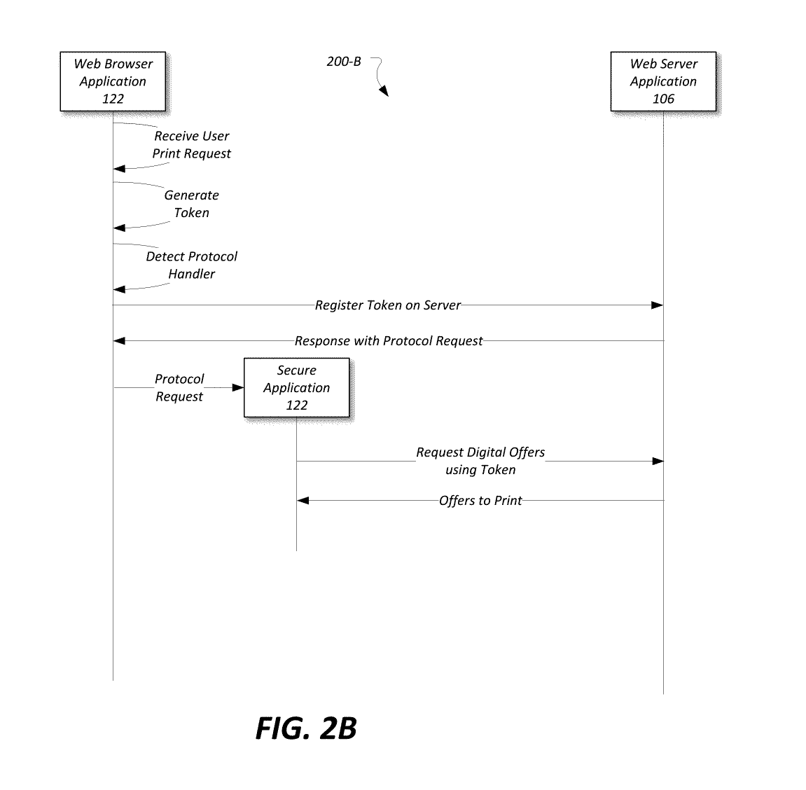

As one possibility, the online offer distribution website 114 may include web page code configured to cause the client device 120 to provide the generated token 130 to the application server 102 when requesting the application installer 126, such that the secure application 124 when installed may be able to be linked via the token 130 to the web session of the web browser 122 requesting the download. As another example, the online offer distribution website 114 may include web page code configured to cause the web browser 122 to provide the generated token 130 to the secure application 124, such that the secure application 124 may provide the token 130 to the application server 102 to link the digital offers 108 being requested 132 by the current web browser 122 session with the secure application 124. Further aspects of the message flow between the client device 120 and the application server 102 are discussed in detail below with respect to FIGS. 2A-2B, 3A-3D and 4-6.

FIG. 2A illustrates an exemplary flow diagram 200 of a client device 120 requesting a digital offer 108 without having a secure application 124 installed. The flow diagram 200 may be initiated, for example, by a user browsing to the online offer distribution website 114 using the web browser 122 of the client device 120, and performing a print request 132 for one or more selected digital offers 108. The client device 120 may accordingly receive the user print request. Responsive to the request, the client device 120 may be configured to execute code of the online offer distribution website 114 to cause the client device 120 to generate a token 130.

When requesting a digital offer 108 from an online offer distribution website 114, the web browser 122 may utilize code of the online offer distribution website 114 to identify whether the secure application 124 is installed on the client device 120. As one example, the code of the online offer distribution website 114 may attempt to navigate to a URL specifying the custom protocol, and may detect that the secure application 124 is not installed if the attempt fails or generates an exception.

When the client device 120 determines that the secure application 124 is not installed, the client device 120 may be configured to execute additional code of the online offer distribution website 114 to cause the client device 120 to request to download an application installer 126 from the application server 102. The application installer 126 may include a packaged version of the secure application 124. Once downloaded, the web browser 122 may prompt the user to execute the application installer 126. When executed, the application installer 126 may be configured to install the secure application 124 on the client device 120. Once installed, the secure application 124 may be executed to complete the request to the application server 102 to print the requested digital offers 108.

To allow the system 100 to link the secure application 124 on the client device 120 back to the original request for digital offers 108 provided by the web browser 122 session, the system 100 may utilize the token 130 generated by the web browser 122. For example, when the secure application 124 is not installed, the web browser 122 may be configured to execute code of the web page to provide the token 130 to the application server 102 in the request to download the application installer 126. The application server 102 may be configured to receive and register the token 130. The application server 102 may further utilize the installer provider 128 to generate a filename that contains or otherwise encodes the token 130, and return the application installer 126 executable named according to the generated filename to the web browser 122.

The application installer 126 that is named by the installer provider 128 according to the token 130 may be referred to herein as a keyed executable. While the name of the application installer 126 may be dynamic, the installer provider 128 may be configured to generate the name including a static portion (such as a prefix indicating the name of the application to be installed), so that users may confirm and accept that the application installer 126 is for installation of the secure application 124.

When the keyed application installer 126 is executed by the client device 120, the application installer 126 may read in its own filename, and decode or otherwise retrieve the token 130. The keyed application installer 126 may then install the secure application 124. Once installed, the keyed application installer 126 may invoke the secure application 124 using the retrieved token 130. As one example, the keyed application installer 126 may pass the token 130 to the secure application 124 as a parameter on a command line passed to the secure application 124 when it is invoked, e.g., using a string of the form “protocol-print [parameters],” similar to the protocol format mentioned above, where “[parameters]” may include the token 130. As another example, the keyed application installer 126 may pass the token 130 to the secure application 124 as part of a protocol request.

Once executed, the secure application 124 may then provide the token 130 to the application server 102 in a request for the digital offers 108. By maintaining the association of the registered token 130 with the web browser 122 session having requested the keyed application installer 126 executable, the application server 102 may accordingly link the newly installed secure application 124 to the existing web browser 122 session from which it was requested. Once linked, the application server 102 may be configured to continue the transaction using the secure application 124, and provide the originally requested digital offer 108 or offers 108 to the user for printing. The secure application 124 may be further configured to inform the application server 102 when the digital offers 108 are successfully printed. Based on the information, the application server 102 may request for the database server 116 to update the database 118 information corresponding to how many print requests 132 are performed for each offer data 112, to allow the offer provider 110 to be able to keep to track of user printing and redemption of digital offers 108.

Thus, as the client device 120 receives the keyed application installer 126 executable with the necessary token 130 information to continue the initial request, the user may be able to install and use the secure application 124 immediately, without requiring further transfer of state information from the web browser 122 to the newly-installed secure application 124. Accordingly, by passing the token 130 according to the installer filename, the system 100 may avoid requesting additional privilege escalation by the user to allow the web browser 122 to communicate with the newly-installed secure application 124.

FIG. 2B illustrates an exemplary flow diagram 200-B of a client device 120 requesting a digital offer 108 with the secure application 124 installed. As with the flow diagram 200-A, the flow diagram 200-B may be initiated, for example, by a user browsing to the online offer distribution website 114 using the web browser 122 of the client device 120, and performing a print request 132 for one or more selected digital offers 108. Responsive to the request, the client device 120 may be configured to execute code of the online offer distribution website 114 to cause the client device 120 to generate the token 130.

When requesting a digital offer 108 from an online offer distribution website 114, the web browser 122 may utilize code of the online offer distribution website 114 to identify whether the secure application 124 is installed on the client device 120. When the client device 120 determines that the secure application 124 is installed, the client device 120 may be configured to execute additional code of the online offer distribution website 114 to register the token 130 with the application server 102. The online offer distribution website 114 may further include code to cause the client device 120 to navigate to a URL of the custom protocol type provided by the application server 102 to the client device 120 responsive to the registered token 130. For example, the online offer distribution website 114 may be configured to cause the web browser 122 to navigate to a URL of the form “printathome:protocol-print [parameters]” as mentioned above, where “[parameters]” may include the token 130. The web browser 122 may identify that the secure application 124 is the application registered to handle the custom protocol request, and may provide the protocol request including the token 130 to the secure application 124 to complete the print transaction. The secure application 124 may provide the token 130 to the application server 102 to allow the application server 102 to identify the requested digital offers, and receive the requested digital offers from the application server 102 for printing.

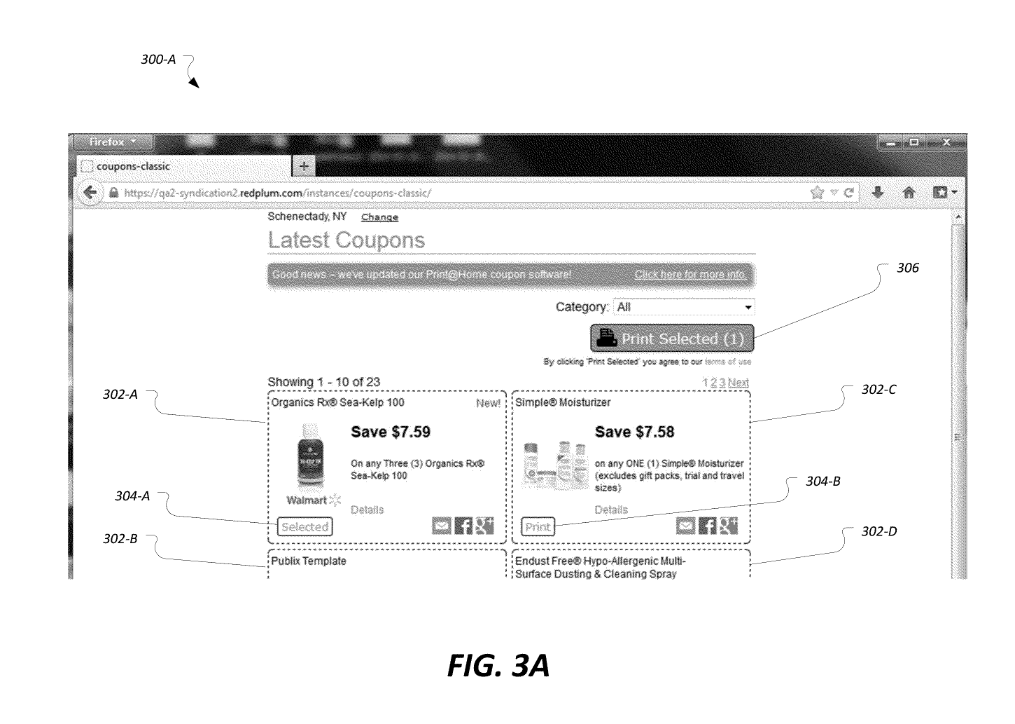

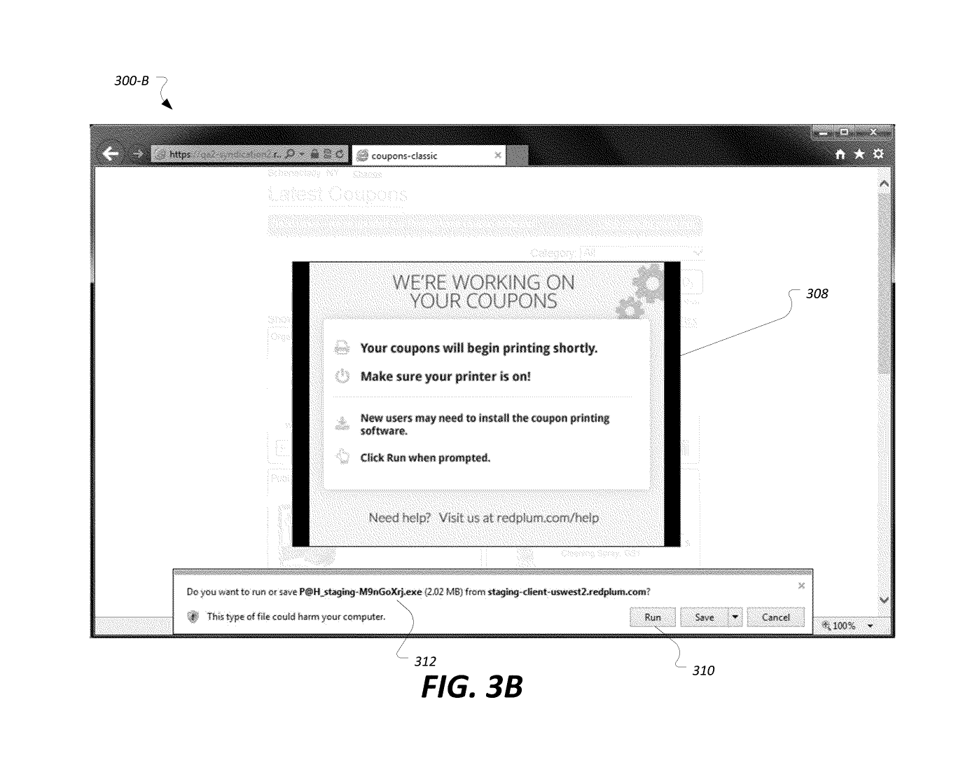

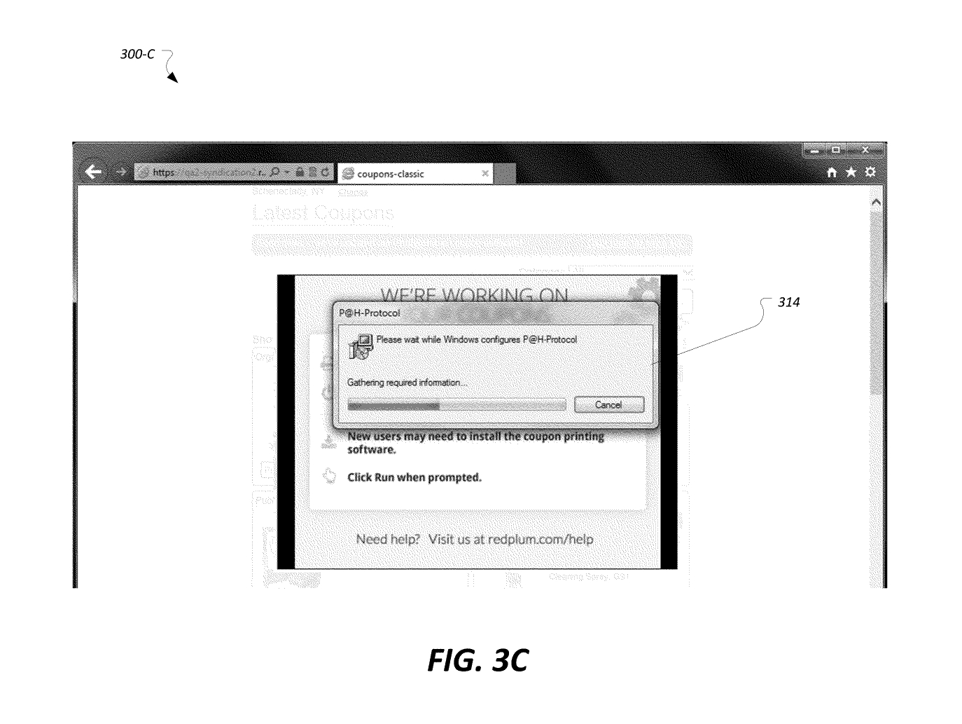

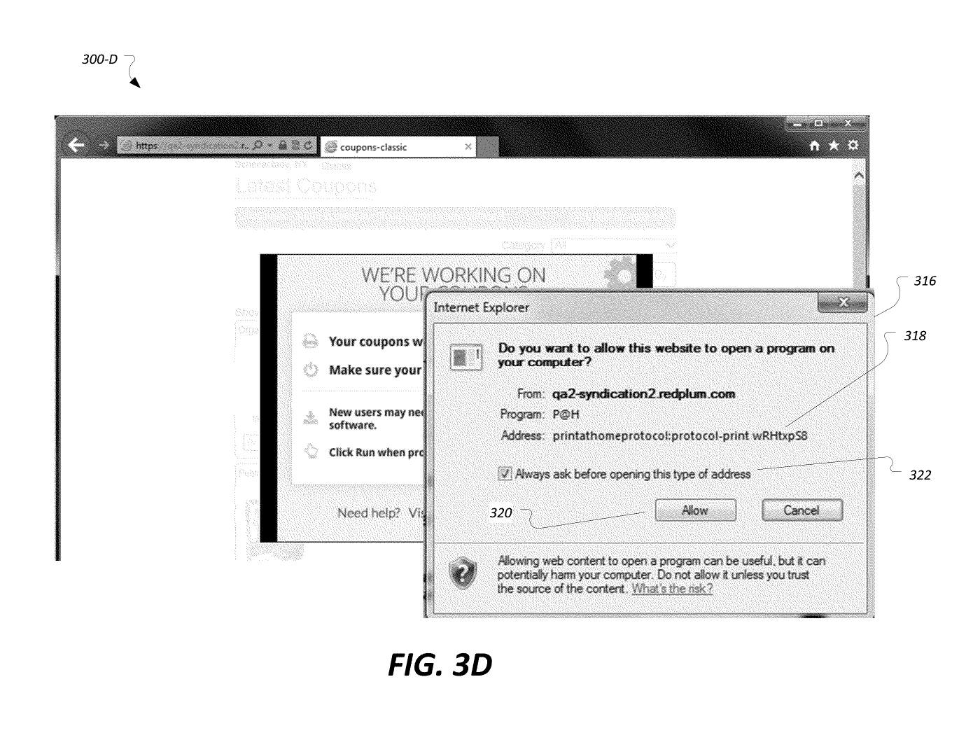

FIG. 3A illustrates an exemplary user interface 300-A of the client device 120 including a web page of the online offer distribution website 114 for requesting digital offers 108. As illustrated, the user interface 300-A includes a plurality of selectable offers indications 302-A through 302-D (collectively 302). Each selectable offers indication 302 corresponds to an available digital offer 108. It should be noted that more or fewer digital offers 108 may be displayed based on various factors, such as what offers 108 are currently being made available by the offer providers 110, and preferences of the user. The user interface 300-A may further include indications 304 that may be selected by the user to choose digital offers 108 to be printed. For example the indication 304-A has been utilized by the user to choose the digital offer 108 corresponding to the selectable offer indication 302-A for printing. However, the user has not selected the indication 304-B to choose the corresponding digital offer 108 for printing. Once the user has chosen the digital offers 108 to be printed, the user may select the print selected control 306 of the user interface 300-A (here indicating one offer 108 to print) to proceed with the request 132 for one or more digital offers 108.

FIG. 3B illustrates an exemplary user interface 300-B of the client device 120 for receiving an application installer 126 of the secure application 124. The user interface 300-B may be displayed when the client device 120 determines that the secure application 124 is not installed. As illustrated, the user interface 300-B includes explanatory information 308 that the selected digital offers 108 will be printed. The explanatory information 308 may further indicate to the user that new users may need to install the secure application 124, and that if so, the users should select a run control 310 if prompted to run an application installer 126 to allow for the printing to proceed. The user interface 300-B may further include a filename indication 312 including the name of the application installer 126, so that the user may identify what application is being installed.

Notably, as illustrated the filename of the application installer 126 includes an encoding of a token 130 (e.g., “M9nGoXrj”). As discussed above, the token 130 may have been provided to the application server 102 by the web browser 122 according to the web site code of the online offer distribution website 114. The application server 102 receiving the token 130 may register the token 130 as associated with the browser session of the web browser 122 (e.g., the request 132 for the digital offer 108-A).

FIG. 3C illustrates an exemplary user interface 300-C of the client device 120 for installing the downloaded secure application 124. As illustrated, the user interface 300-C includes a dialog 314 indicating the installation progress of the secure application 124. Once installed, the keyed application installer 126 may execute the secure application 124, and may pass the token 130 to the secure application 124. For example, the keyed application installer 126 may invoke the keyed application installer 126 with a command line including the token 130, such as, “protocol-print M9nGoXrj.”

The secure application 124 may, in turn, provide the token 130 (e.g., M9nGoXrj) to the application server 102 to continue the print request 132 transaction. The application server 102 may accordingly identify, based on the received token 130, that the secure application 124 is associated with the request 132 for the digital offer 108-A. Using the facilities of the secure application 124, the client device 120 may accordingly receive and print the requested digital offer 108-A.

FIG. 3D illustrates an exemplary user interface 300-D of the client device 120 including a web page of the online offer distribution website 114 for performing a protocol request to invoke the secure application 124 to complete the digital offer request 132. Similar to the user interface 300-B, the user interface 300-D may be displayed responsive to user selection of the print selected control 306 of the user interface 300-A. However, as compared to the user interface 300-B, the user interface 300-D may be displayed when the client device 120 determines that the secure application 124 is installed.

As discussed above, a token 130 may be generated by the web browser 122 according to the web site code of the online offer distribution website 114 and provided to the application server 102. The application server 102 receiving the token 130 may associate the token 130 with the browsing session of the web browser 122 (e.g., the request 132 for the digital offer 108-A), and may provide a protocol request back to the web browser 122, where the protocol request specifies the token 130 registered as associated with the client device 120. For instance, the protocol request may include an encoding of a token 130 (e.g., “wRHtxp58”) in the URL of the protocol request.

To perform the protocol request, the user interface 300-D may display a permission dialog 316 requesting permission from the user to proceed with execution of the secure application 124 to receive and print the requested digital offer 108-A. For example, the user may be required to select the allow control 330 of the user interface 300-D. Moreover, the permission dialog 316 may further include a default permission control 322 that may be adjusted by the user to always allow protocol requests to invoke the secure application 124. Thus, when the default permission control 322 is allow such requests, the user interface 300-D may not be displayed by the client device 120, and the requests 132 may simply proceed responsive to user selection of the print selected control 306 of the user interface 300-A. (It should be noted that the specific options available in the user interface 300-D with respect to permission control may vary according to operating system and browser version.)

When executed, the protocol request may be routed to the registered handing application (i.e., the secure application 124), which may retrieve the token 130 from the command line forwarded from the web browser 122 to the secure application 124 (e.g., “protocol-print wRHtxp58”). The secure application 124 may, in turn, provide the token 130 to the application server 102 to continue the print request 132 transaction. The application server 102 may accordingly identify, based on the received token 130, that the secure application 124 is associated with the request 132 for the digital offer 108-A. Using the facilities of the secure application 124, the client device 120 may receive and print the requested digital offer 108-A.

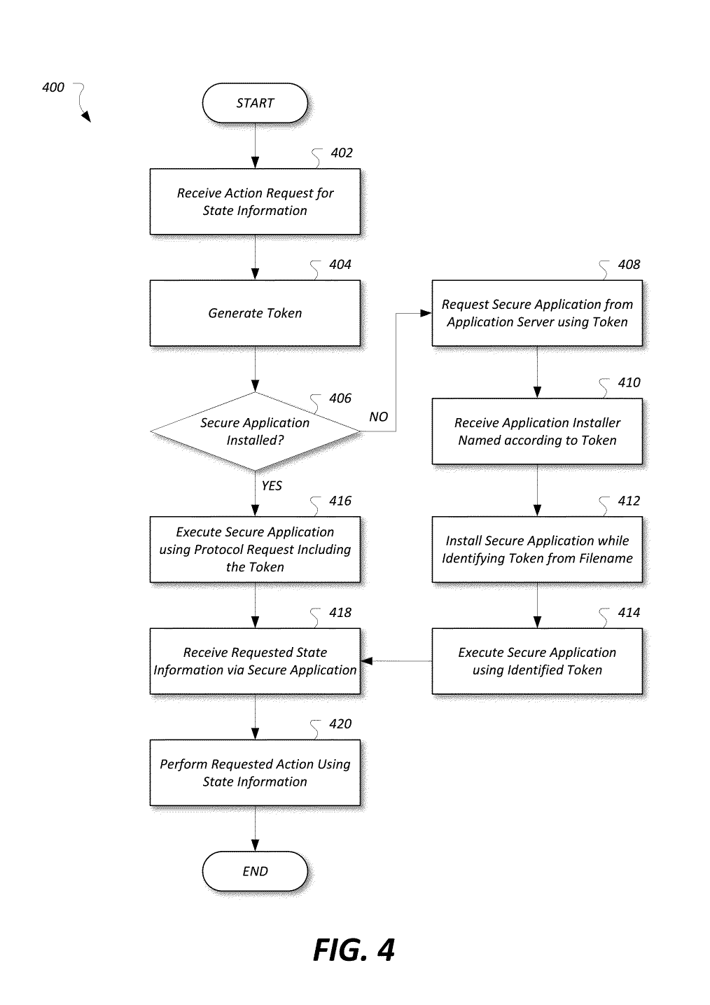

FIG. 4 illustrates an exemplary process 400 for printing digital offers 108 provided by the application server 102 to the client device 120. The process 400 may be performed, for example, by the client device 120 in communication with the application server 102 over the network 104.

At block 402, the client device 120 receives an action request utilizing browser state information. For example, the user of the client device 120 may browser to the online offer distribution website 114, select one or more electable offers indications 302 corresponding to one or more available digital offers 108, and choose the print selected control 306 of the user interface 300-A to proceed with the print action request 132 for one or more digital offers 108.

At block 404, the client device 120 generates a token 130. For example, the token 130 may be generated by the web browser 122 according to the web site code of the online offer distribution website 114.

At decision block 406, the client device 120 determines whether the secure application 124 is installed. For example, the web browser 122 may utilize code of the online offer distribution website 114 to identify whether the secure application 124 is installed on the client device 120. As one example, the code of the online offer distribution website 114 may attempt to navigate to a URL specifying the custom protocol, and may detect that the secure application 124 is not installed if the attempt fails or generates an exception. If the secure application 124 is not installed, control passes to block 408. Otherwise, control passes to block 416.

At block 408, the client device 120 requests the secure application 124 from the application server 102 using the token 130. For example, the client device 120 may be configured to execute additional code of the online offer distribution website 114 to cause the client device 120 to request to download an application installer 126 from the application server 102.

At block 410, the client device 120 receives the application installer 126 named according to the token 130. For example, the client device 120 may receive the application installer 126 from the installer provider 128.

At block 412, the client device 120 installs the secure application 124 while identifying the token 130. For example, when the keyed application installer 126 is executed by the client device 120, the application installer 126 may read in its own filename, and decode or otherwise retrieve the token 130. The keyed application installer 126 may then install the secure application 124.

At block 414, the client device 120 executes the secure application 124 using the token 130. For example, once installed, the keyed application installer 126 may invoke the secure application 124 using the retrieved token 130. After block 414, control passes to block 418.

At block 416, the client device 120 executes the secure application 124 using a protocol request including the token 130. For example, the client device 120 may be configured to execute code of the online offer distribution website 114 to register the token 130 with the application server 102. The online offer distribution website 114 may further include code to cause the client device 120 to navigate to a URL of the custom protocol type provided by the application server 102 to the client device 120 responsive to the registered token 130. The web browser 122 may identify that the secure application 124 is the application registered to handle the custom protocol request, and may provide the protocol request including the token 130 to the secure application 124.

At block 418, the client device 120 receives the requested state information from the application server 102. For example, the secure application 124 may provide the token 130 to the application server 102 to allow the application server 102 to utilize the associated web browser state information to identify the requested digital offers 108, and receive the requested digital offers 108 from the application server 102 for printing.

At block 420, the client device 120 performs the requested action using the state information. For example, the secure application 124 may print the received digital offers 108 to a printer of the client device 120. Once printed, the digital offers 108 may be redeemed by the user at retailers or other POS locations. After block 420, the process 400 ends.

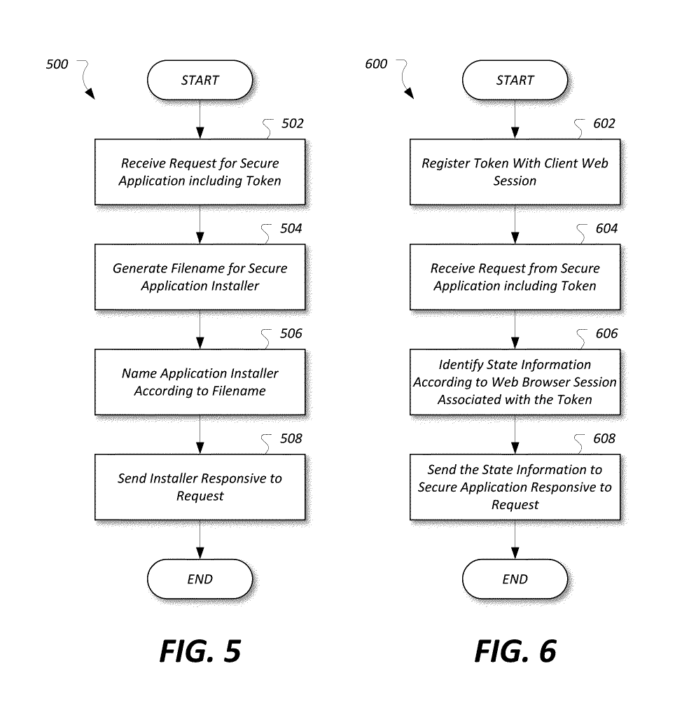

FIG. 5 illustrates an exemplary process 500 for providing the secure application 124 to the client device 120 from the application server 102. The process 500 may be performed, for example, by the application server 102 in communication with the client device 120 over the network 104.

At block 502, the application server 102 receives a request for the secure application 124 including the token 130. For example, the web server 106 of the application server 102 may receive a token 130 generated by the web browser 122 of the client device 120 utilizing code of the online offer distribution website 114 provided to the web browser 122 by the web server 106.

At block 504, the application server 102 generates a filename for the secure application 124 based on the token 130. For example, the installer provider 128 of the application server 102 may receive the request, and generate a filename according to the token 130. While the name of the application installer 126 may be dynamic, the installer provider 128 may be configured to generate the name including a static portion (such as a prefix indicating the name of the application to be installed), so that users can confirm that the application installer 126 is for installation of the secure application 124.

At block 506, the application server 102 names the application installer 126 according to the generated filename. For example, the installer provider 128 may name a copy of the application installer 126 according to the generated filename.

At block 508, the application server 102 sends the application installer 126 to the client device 120 responsive to the request. For example, the web server 106 may send the named copy of the application installer 126 from the installer provider 128 to the client device 120. After block 508, the process 500 ends.

FIG. 6 illustrates an exemplary process 600 for providing digital offers 108 from an application server 102 to a client device 120 executing a secure application 124. As with the process 500, the process 600 may be performed, for example, by the application server 102 in communication with the client device 120 over the network 104.

At block 602, the application server 102 registers a token 130 with a web session of the web browser 122 of the client device 120. For example, the application server 102 may receive the token 130 generated by the client device 120 according to web page code of the online offer distribution website 114. The application server 102 may receive the token 130 and register the token 130 in association with the session of the client device 120, such that later requests to the application server 102 from the secure application 124 may be linked to the state information of the web browser 122 session providing the token 130.

At block 604, the application server 102 receives a request from the secure application 124 including the token 130. For example, the application server 102 may receive the token 130 in a request from the secure application 124 executed by the client device 120 to complete the print transaction such as described above with respect to block 418 of the process 400.

At block 606, the application server 102 identifies state information according to the web browser 122 session associated with the token 130. For example, the application server 102 may identify the requested digital offers 108 of the web browser 122 session associated in block 602 with the provided token 130.

At block 608, the application server 102 sends the identified state information to the secure application 124 responsive to the request. For example, using the state information of the identified browser session linked to the token 130, the application server 102 may provide the requested digital offers 108 from the application server 102 for printing. The application server 102 may be further configured to update the database server 116 regarding the printing of the digital offers 108 to update the digital offer 108 statistics. As another example, the application server 102 may be configured to update the database server 116 regarding the total time elapsed between registering the token 103 at block 602 and sending or printing of the requesting digital offers 108 by the client device 120. After block 608, the process 600 ends.

In general, computing systems and/or devices, such as the application server 102, offer provider 110, database server 116 and client device 120, may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, a computer workstation, a server, a desktop, notebook, laptop, or handheld computer, or some other computing system and/or device.

Computing devices such as the such as the application server 102, offer provider 110, database server 116 and client device 120, generally include computer-executable instructions such as the instructions of the web server application 106, web browser 122, secure application 124 and installer provider 128, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Objective C, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein, such as the database 118, may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
an application server configured to
register a received token, generated by a web browser client of a client device, as being associated with a web session of the web browser client,
receive a request including the token from a secure application of the client device,
identify state information according to the web session of the web browser client associated with the token, and
send the state information to the secure application of the client device responsive to the request.

2. The system of claim 1, wherein the application server is further configured to:
receive a download request from the web browser client to download the secure application,
name the secure application according to a generated filename including an encoding of the token, and
provide an installer application of the secure application to the web browser client to install the secure application on the client device responsive to the download request, the installer application being named in accordance with the generated filename.

3. The system of claim 2, wherein the generated filename includes a static portion identifying a purpose for installer application and a dynamic portion including the encoding of the token.

4. The system of claim 3, wherein the static portion is a filename prefix.

5. The system of claim 1, wherein the state information includes indications of selected digital offers, and the request includes a print request to print the digital offers by the client device.

6. The system of claim 5, wherein the application server is further configured to:
include a plurality of selectable offers indications in a website provided to the web browser client;
receive selection of the digital offers according to the plurality of selectable offers indications; and
receive the print request from the web browser client responsive to user selection of a print control included in the website.

7. The system of claim 6, wherein the token is a unique identifier generated by the client device according to web page code of the website provided to the client device by the application server.

8. A system for distributing digital offers comprising:
a client device configured to
generate a token uniquely identifying the client device according to web page code of a website provided to the client device from an application server in a web session,
send the token to the application server to cause the application server to associate the token with the web session,
send a request including the token from a secure application of the client device, and
receive state information associated with the web session from the application server responsive to the request.

9. The system of claim 8, wherein the client device is further configured to determine whether the secure application is installed on the client device.

10. The system of claim 9, wherein the client device is further configured to:
identify whether the secure application is installed on the client device by attempting a navigate action to a universal resource locator specifying a custom protocol handled by the secure application; and
detect whether the secure application is installed according to whether the attempt is successful.

11. The system of claim 8, wherein the client device is further configured to request the secure application from the application server using the token when the secure application is not installed on the client device.

12. The system of claim 11, wherein the client device is further configured to:
receive an application installer configured to install the secure application on the client device responsive to the request for the secure application;
retrieve the token according to a filename of the application installer;
install the secure application using the application installer; and
execute the secure application using the token retrieved from the filename.

13. The system of claim 12, wherein the filename includes a static portion identifying a purpose for installer application and a dynamic portion including an encoding of the token suitable for filenames, and wherein the installer application is further configured to retrieve the token from the dynamic portion of the filename.

14. The system of claim 13, wherein the static portion is a filename prefix.

15. The system of claim 11, wherein the client device is further configured to:
receive selection of a plurality of selectable offers indications in a website provided to the client device, the plurality of selectable offer indications identifying to the application server the digital offers associated with the web session; and
send the request to the application server responsive to user selection of a print control included in the website,
wherein the state information includes indications of selected digital offers, and the request includes a print request to print the digital offers by the client device.

16. A method for distributing digital offers comprising:
generating, by a client device, a token uniquely identifying the client device according to web page code of a website provided to the client device from an application server in a web session,
sending the token by the client device to the application server to cause the application server to associate the token with the web session,
sending a print request including the token from a secure application of the client device, and
receiving, responsive to the token of the print request, digital offers associated with the web session from the application server for printing by secure application.

17. The method of claim 16, further comprising:
identifying whether the secure application is installed on the client device by attempting a navigate action to a universal resource locator specifying a custom protocol handled by the secure application; and
detecting whether the secure application is installed according to whether the attempt is successful.

18. The method of claim 17, wherein the client device is further configured to request the secure application from the application server using the token when the secure application is not installed on the client device.

19. The method of claim 18, wherein the client device is further configured to:
receiving an application installer configured to install the secure application on the client device responsive to the request for the secure application;
retrieving the token according to a filename of the application installer;
installing the secure application using the application installer; and
executing the secure application using the token retrieved from the filename.

20. The method of claim 19, wherein the filename includes a static portion identifying a purpose for installer application and a dynamic portion including an encoding of the token suitable for filenames, and wherein the installer application is further configured to retrieve the token from the dynamic portion of the filename.

21. The method of claim 17, wherein the client device is further configured to:
receiving selection of a plurality of selectable offers indications in a website provided to the client device, the plurality of selectable offer indications identifying to the application server the digital offers associated with the web session; and
sending the print request to the application server responsive to user selection of a print control included in the website.
